(19) United States
(12) Patent Application Publication
(10) Pub. No.: US 2017/0249394 A1
(43) Pub. Date: Aug. 31, 2017

(54) SCALABLE PRIVACY PROTECTED WEB CONTENT SHARING MECHANISM FOR WEB BASED APPLICATIONS

(71) Applicant: INTERDIGITAL TECHNOLOGY CORPORATION, Wilmington, DE (US)

(72) Inventors: Shoshana LOEB, Philadelphia, PA (US); Mohamed K. HASSANIN, Framingham, MA (US); Kuo-Chu LEE, Princeton Junction, NJ (US); Zijun YAO, North Arlington, NJ (US)

(73) Assignee: InterDigital Technology Corporation, Wilmington, DE (US)

(21) Appl. No.: 15/521,805

(22) PCT Filed: Nov. 3, 2015
(86) PCT No.: PCT/US2015/058815

§ 371 Date: Apr. 25, 2017

Related U.S. Application Data
(60) Provisional application No. 62/074,399, filed on Nov. 3, 2014.

(51) Int. Cl. G06F 17/30; H04W 12/02; H04L 29/06; H04L 29/08; H04L 12/18; H04L 12/58

(52) U.S. Cl. CPC G06F 17/30873; H04L 12/1822; H04L 51/12; H04L 63/0407; H04L 67/02; H04W 12/02

(57) ABSTRACT

Embodiments for sharing a web session with privacy protected content with a between a primary user and a secondary user is described. A request may be transmitted to a service server by the primary user. The request may include a command to create a shared session to share portions of a web session with the secondary user and a first uniform resource locator (URL) corresponding with the web session to be shared. The primary user may mark content of the webpage as privacy protected content, which may not be shared with the secondary user. The privacy protected content may be replaced by content targeted to the secondary user during the shared session. The parameters and marked content may be transmitted to the service server. The primary user may receive a second URL for the shared session and may transmit it to the secondary user.

### CROSS REFERENCE TO RELATED APPLICATIONS

This application is the U.S. National Stage, under 35 U.S.C. §371, of International Application No. PCT/US2015/058815 filed Nov. 3, 2015, which claims the benefit of U.S. Provisional Application No. 62/074,399 filed on Nov. 3, 2014, the contents of which is hereby incorporated by reference herein.

### BACKGROUND

Applications for allowing a user to share a session with other users are gaining popularity. These applications include shared shopping sessions, shared content creation sessions, shared gaming sessions, and shared training sessions. These applications often pose privacy issues. For example, a portion of a user's screen may be perceived as private and the user may want to have better control over whom to share that portion of the screen with. Private portions of a user's screen may include personalized advertisements that are based on prior browsing history, private purchase history data, cookies collected by the browser, advertisement servers in the website, or the like.

There are different types of screen capture and sharing methods. For example, Web Real Time Communications (WebRTC) is a browser communication tool standard adopted by many browsers. WebRTC has been used to support browser screen sharing. WebRTC provides ubiquitous real-time communications natively in a web browser via standard hypertext transfer protocol (HTTP) and hypertext markup language (HTML) 5, without plug-ins or extensions.

WebRTC is supported by many popular browsers and there is speculation regarding the development of WebRTC support for other popular browser as well. Generally, all that is required from WebRTC users is a uniform resource locator (URL) that they may navigate to in order begin screen sharing. After navigating to the URL, the user may start a live real-time communication session. This session may be audio, video, audio/video, data, or the like.

### SUMMARY

In an embodiment, a method for protecting a primary user's privacy during a shared web session is disclosed. The method may include: selecting shareable content on a screen that should be shared with a secondary user in a shared session, wherein the shareable content comprises regions of the screen; selecting private content on the screen that should be blocked from the secondary user in the shared session, wherein the private content comprises regions of the screen; sending a request to a service server to create a shared session so that only the selected shareable content of the screen is available to the secondary user; receiving a URL from the service server, wherein the URL connects the secondary user to the shared session; and sending the URL to the secondary user to enable the secondary user to view the shared screen.

In an embodiment, a system for protecting a primary user's privacy during a shared web session is disclosed. The system may include: a communications interface; a memory coupled to the communications interface, wherein the memory stores an electronic request processing application; and a processor in communication with the memory, wherein the processor executes the electronic request processing application stored in the memory, the electronic request processing application comprising program instructions for: selecting shareable content on a primary user's screen that should be shared with a secondary user in a shared session, wherein the shareable content comprises regions of the screen; selecting private content on the primary user's screen that should be blocked from the secondary user in the shared session, wherein the private content comprises regions of the screen; sending a request to a service server to create a shared session so that only the selected shareable content of the screen is available to the secondary user; receiving a URL from the service server, wherein the URL connects the secondary user to the shared session; and sending the URL to the secondary user to enable the secondary user to view the shared screen.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an example communications system in which one or more disclosed embodiments may be implemented;

FIG. 2 is a system diagram of a web content sharing service with privacy protection;

FIG. 3 is a diagram of a graphical user interface (GUI) for manually tagging privacy and public tags to webpage elements;

FIG. 4 is a diagram illustrating how a privacy enforcement rule function may extract a set of privacy control metadata from a privacy tagged webpage in a primary user's browser;

FIG. 5 is a flow diagram of an example privacy protected web content sharing message call flow;

FIG. 6 is a flow diagram of a dynamic update and reload call flow;

FIG. 7 is a flow diagram of a synchronization call flow between the primary user and a secondary user; and

FIG. 8 is a diagram of enhancement functions located at the service server, the primary user, and the one or more secondary users.

### DETAILED DESCRIPTION

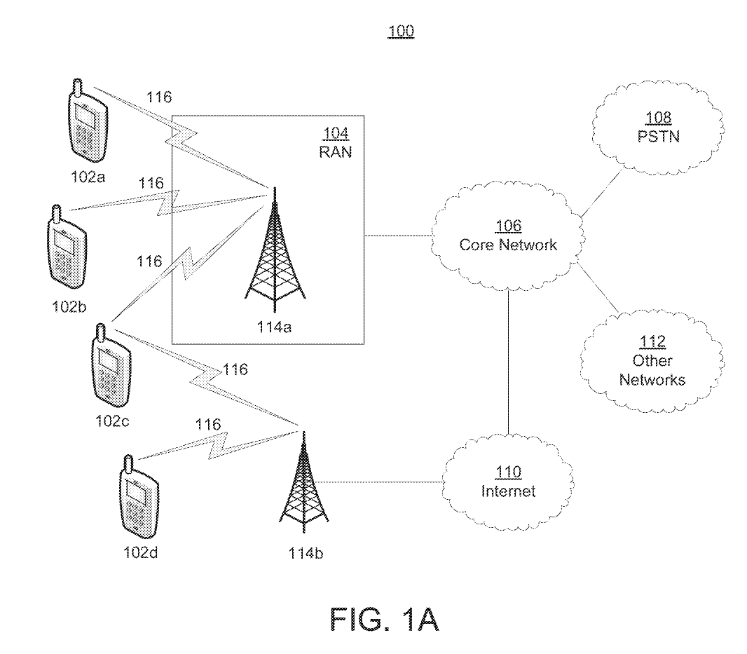

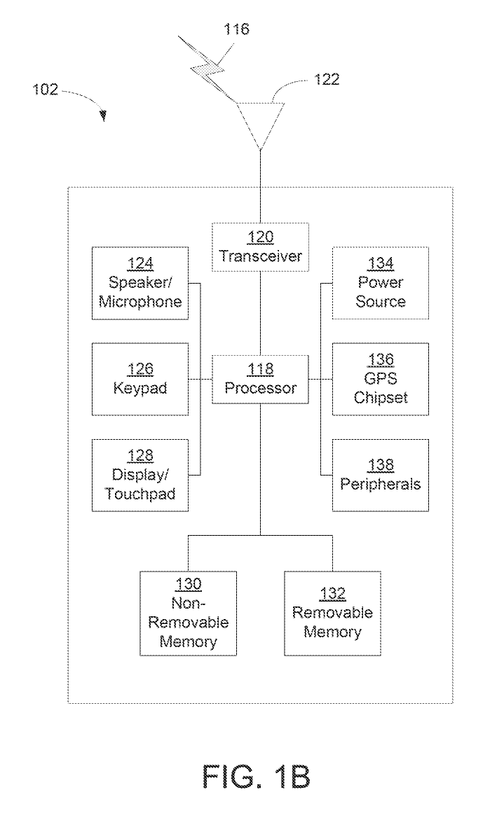

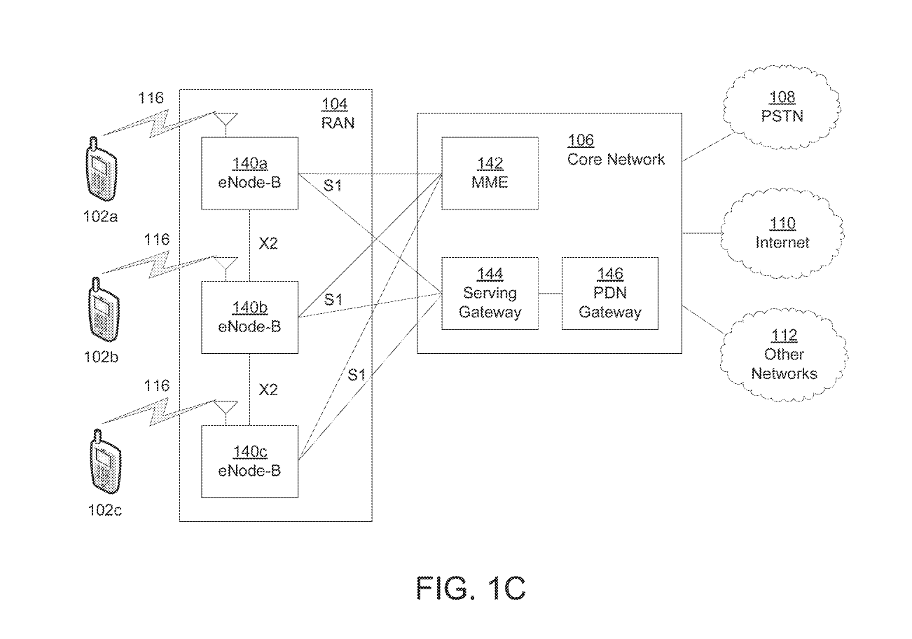

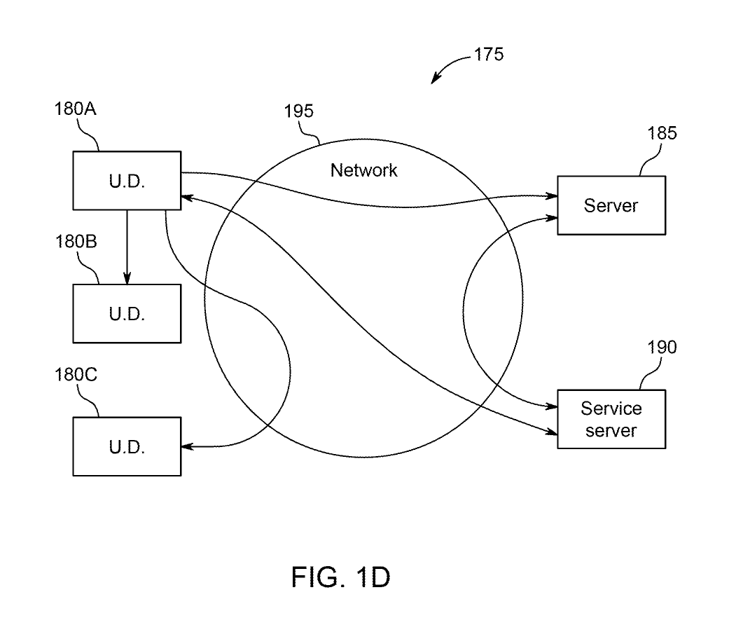

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an Si interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the Si interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Other network 112 may further be connected to an IEEE 802.11 based wireless local area network (WLAN) 160. The WLAN 160 may include an access router 165. The access router may contain gateway functionality. The access router 165 may be in communication with a plurality of access points (APs) 170a, 170b. The communication between access router 165 and APs 170a, 170b may be via wired Ethernet (IEEE 802.3 standards), or any type of wireless communication protocol. AP 170a is in wireless communication over an air interface with WTRU 102d.

FIG. 1D is a system diagram of an example communications system 175 in which one or more disclosed embodiments may be implemented. In some embodiments, communications system 175 may be implemented using all or a portion of system 100 as shown and described with respect to FIG. 1A.

User device 180a, server 185, and/or service server 190 may communicate over communications network 195. These communications may be wireless, wired, or any combination of wireless and wired. Communications network 195 may include the internet 110, core network 106, other networks 112, or any other suitable communications network or combination of communications networks.

User device 180a may include a WTRU (such as WTRU 102a), or any suitable user computing and/or communications device such as a desktop computer, web appliance, interactive television (ITV) device, gaming console (such as Microsoft XBOX™ or Sony Playstation™) or the like. User device 180a and/or applications executing on user device 180a may generate events such as mouse clicks, keyboard strokes, and the like. These events may be processed by user device 180a and/or may be transmitted to another device such as server 185 or service server 190.

Server 185 may include a web server, application server, data server, or any combination of these or other types of servers. Server 185 may include any suitable server device such as a server computer, personal computer, or the like. Server 185 may host applications accessible to user device 185a. For example, server 185 may include a gaming server hosting a massively multiplayer online game (MMOG), an email server, a web server hosting a website such as a social media website or blog, or other types of servers typically accessible by a user device over a computer communications network.

User device 180a may access server 185 over computer communications network 175 to interact with services that it provides. For example, user device 180a may access a game server hosted on server 185 to participate in a multiplayer online game. Access of server 185 by user device 180a may be via a client application executing on user device 180a or any other suitable mechanism. In some cases, the server 185 may receive events from user device 180a, or may send events to user device 180a. For example, the server 185 may send an event to user device 180a indicating that additional in-game resources are required for continued play.

Service server 190 may include a web server, application server, data server, or any combination of these or other types of servers hosted on a server device. Service server 190 may include any suitable server device such as a server computer, personal computer, or the like. Service server 190 may be configured to communicate with server 185, for example, over network 195 or any other suitable communications medium. Service server may be co-located with, combined with, or in direct communication with server 185.

Service server 190 may communicate with server 185 to provide services, such as third party services, to users of server 185. For example, a subscriber to a game hosted on server 185 may access server 185 from user device 180A and may subscribe to third party services for the game which are hosted on service server 190.

Service server 190 may be configured to receive and/or intercept events transmitted between user device 180a and server 185. For example, in some embodiments server 185 and service server 190 may be configured such that server 185 may send an event destined for user device 180a instead or additionally to service server 190, and service server 190 may send the event or another event, signal, or message to device 180a. For instance, in a case where server 185 includes a game server, server 185 may send an event to service server 190 indicating a requirement of a user of user device 180a, and server 190 may send the event or another signal or message to device 180a indicating that a resource is available to acquire the requirement. In some embodiments, service server 190 may only forward the event to device 180a under certain conditions, such as based on a user preference and/or context information relating to the user of device 180a.

In some embodiments, the functions of service server 190 and server 185 may be implemented using the same device, or across a number of additional devices.

In some embodiments, user devices 180b and 180c may communicate with server 185 and/or service server 190 via user device 180a. For example, user device 180a may forward a notification message from service server 190 to user device 180b via a peer to peer connection and may forward a notification message from service server 190 to user device 180c via network 195. In some embodiments, user devices 180a, 180b, and 180c may form a network, such as a peer-to-peer network, and such network may have a mesh topology, a star topology using user device 180a as a coordinating node, or any other suitable topology. In such embodiments, the peer-to-peer network may operate independently of server 185 and/or service server 190, and may incorporate functionality that otherwise would be hosted by server 185 and/or service server 190, such as functionality described herein.

The following methods, systems, and apparatuses may be deployed in any one of the networks as described above.

Traditional screen sharing solutions may capture the screen, or part of the screen, and may transmit it to one or more spectating users. For example, a sharing user may use screen snipping tools to manually cut and share a region of the screen. However, manual operation may not be adopted by most screen sharing technologies or browser sharing applications. This may be because manual operation may not be user friendly. In addition, manual operation may be slow, especially when sharing a sequence of web contents.

When using co-browsing tools, which allow users to share browsing information with technical support users or other users, privacy protection methods may be employed to protect personal data. For example, privacy tags may be added to HTML elements that may contain personal data; web server page designs may be modified; or privacy protection application programming interface (API) scripts for webpage developers may be inserted to filter personal data elements.

However, one of the challenges in the privacy protection methods described heretofore is that it may still be possible to derive something which has been masked from other non-masked information on the web page. These methods were intended to protect predefined personal data elements (e.g., elements known to the web page provider/designer). These methods may require web page providers/designers to design webpages in consideration of personal data. The resulting system designs may not be generally applied to all webpages (e.g., to all portions of arbitrary webpages).

In particular, such system designs may not protect user privacy with regard to dynamic web content displayed alongside main page content containing ads and other content that may reflect personal information, such as preference and browsing histories. For webpage sharing, the webpage itself may have most of the descriptive information required to display different regions (e.g., Iframes), in a webpage, namely, the HTML markup of the page, to the viewers.

Methods to utilize this information to preserve privacy of the primary user (i.e., a sharing user) for dynamic web content generated by websites and search engines using personal information will be described. In one embodiment, a method may be used to support different types of content sharing services and may observe how much the search engine and website have learned about personal information. The method may reduce the bandwidth requirements of screen sharing and, therefore, may scale well for many secondary or spectating users.

In another embodiment, the webpage sharing method may include sharing of any content, such as slide show content, video content, animation content, web frames, HTML elements, session information, and the like. The method may allow for the primary user to delegate additional privileges and controls of the shared page to the secondary users. When in a mobile application or game environment, a primary user may use the web content sharing service to share part of an application session. This may consist of a progression of different content shown in the same session under a single URL or multiple URLs. For example, the primary user may want to share a session of play with another user or discuss a resource to purchase with other users. In another example, the primary user may be providing a tutorial to a set of users or may be having a problem within an application and may need to share the problem context with a support staff user while sharing page content with another user.

When a user of a web-based application shares their screen with other users in a session, all elements in a given area on the screen may be exposed to the other users of the session. This may represent a violation of the user's privacy as the user's screen may contain targeted advertisements or other personalized items that the user does not want to expose. Therefore, a scalable user-configurable privacy preserving solution to screen sharing is desired.

Embodiments for preventing the display of private parts of the screen to secondary or spectating users will now be described. A primary or sharing user may grant certain secondary users or spectating users permission to view certain private aspects of the shared webpage if that user so desires. The private unshared parts of the screen may be used to display targeted advertisements for the secondary or spectating user.

Alternatively, advertisements may be completely blocked using advertisement blocker add-ons or plug-ins. However, advertisement blockers may block desired content or advertisements that the user may want to share, (e.g., an interesting product preview from a main website or from a third party advertisements server). In addition, some mobile applications may have in-application or in-game advertisements that a user may or may not wish to share.

In the embodiments described herein, the primary user may be engaged in a web session. The web session may be in a laptop browser, an HTML based mobile application, a game, or the like. The primary user may wish to initiate sharing part of the contents of the primary user's screen with other users (e.g., secondary users or spectating users). The primary user may send a request to a service server to create a shared session. It should be noted that the service server may be the original web server, a separate server device operated by the webpage provider, or some other server. Alternatively, the service server may be a separate server device operated by a third-party, which may or may not have a relationship with the original webpage provider.

The primary user may supply a URL to each of the secondary users to enable the secondary users to view the shared screen. The secondary users may then navigate to the URL and being viewing the webpage. The secondary users may view the contents of the webpage and any actions taken by the primary user.

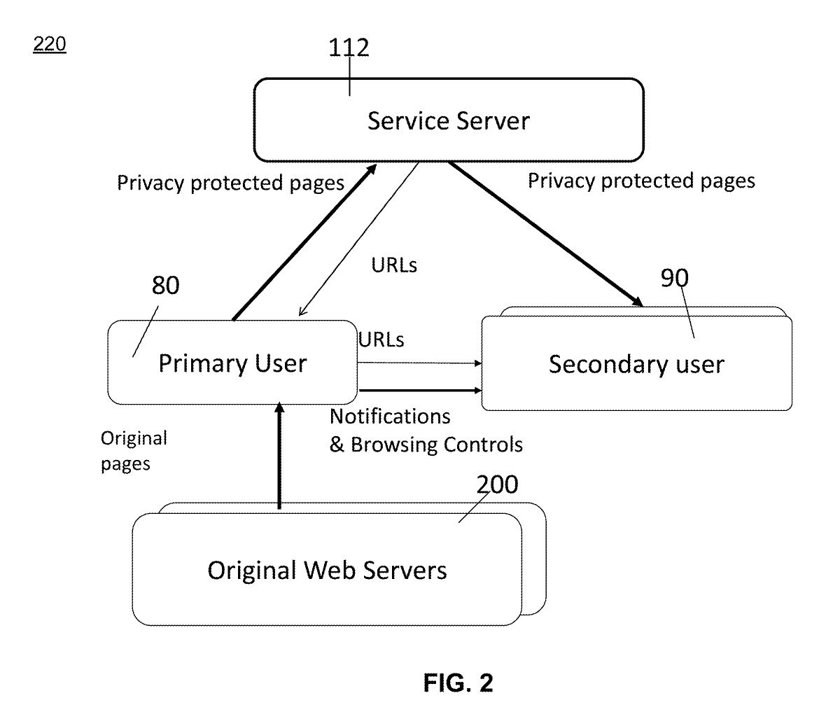

FIG. 2 is a system diagram 220 of a web content sharing service with privacy protection. In such a system, a webpage transmitted to a secondary user 90 may have areas that are private to a primary user 80 and may not be displayed to the secondary user 90. Targeted advertisements (e.g., advertisements targeted to a specific secondary user 90) may be displayed in those private areas of the webpage. In addition, at any time, one of the shared session users (i.e., secondary users 90) may be given or may assume the role of a primary user 80 and may establish the above shared session connection with the service server.

Web contents provided by a website or third party advertising server network 200 may be loaded into the webpage from external source uniform resource identifiers (URIs), which may be dynamically based on a timer or user reloading of the webpage. For different advertisements, the source URIs may be different. When sharing a webpage URL with dynamic URI content, the primary user 80 may be unable to predict if undesirable private content or advertisements dynamically loaded from the URIs will be displayed and shared with secondary users 90. Therefore, tracking and analysis of history of URIs of all the dynamic loaded web content may provide insightful information regarding protection of the primary user's private portion of the web contents. It should be noted that these contents may be dynamic and may not be tagged as private elements by a webpage designer.

In an example scenario, a webpage may already be loaded on a primary user's 80 browser. The primary user 80 may be actively browsing through the contents already on the webpage or engaging in activities, such as browsing through an inventory of merchandise or playing an online game. This activity may generally be referred to as a web session. At some point during the web session, the primary user 80 may desire to share portions of the web content to other users (e.g., secondary users 90), so that the secondary users 90 may view the primary user's web content without seeing portions of the web content that may reveal private personal information of the primary user 80.

The primary user 80 may send a signal to a service server 112. The signal may include an indication of a need to add one or more secondary users 90. This request may be initiated by the primary user 80 clicking a button on the browser with a web content sharing add-on function, through an app that is running on the primary user's 80 device, or through a service provided by the webpage that the user is navigating. The add-on functionality may be packaged as a software development kit (SDK) that may be deployed in the browser or in a server remotely.

After the request is received from the primary user 80, the service server 112 may initiate a process to collect any necessary parameters from the primary user's 80 webpage. The parameters may include an indication of whether the session is password protected. If the session is password protected, a subscription process may set up a password and access token for the primary user. The primary user 80 may have an option to share content to a list of secondary users 90 dynamically. In that case, the access token may be used as a password for the secondary user 90 to access the shared content.

Another parameter may include an indication of the state of the webpage's functionality of screen sharing. For example, some items being displayed may be required; however, private information items such as the contents of a primary user's 80 shopping basket on an ecommerce website or the primary user's 80 credit card number and other personal information would not be shared. This distinction may preserve the security and privacy of the primary user 80.

If the current website lacks certain functionality, the service server 112 may create a new webpage (that may possibly be the same as the old webpage), and may format that webpage to be shared. Stated differently, the service server 112 may add any necessary functionality to provide privacy to the primary user 80. For example, this may include enclosing any private parts of the webpage in frames and adding control buttons to such frames. The webserver may then provide the primary user 80 with a dedicated URL for the primary user's 80 shared session with secondary users 90.

The dedicated session link may be communicated to users (e.g., primary users 80 and secondary users 90) in various ways. In one embodiment, the webserver 200 may provide functionality to send an email invitation to one or more secondary users 90. The email invitation may include a request that the secondary users 90 join the session. In another embodiment, the webserver 200 may have a directory of secondary users 90 that have been pre-registered. In this example, the primary user 80 may select one or more secondary users 90 from the directory provided by the webserver 200.

In another embodiment, the primary user 80 may have a “contact list.” The primary user 80 may use the contacts list to select one or more secondary users 90 from the contact list by searching (e.g., by first name, last name, user name, etc.). In yet another embodiment, the primary user 80 may choose to send the link to the secondary users 90 via an independent channel, such as texting the URL to the secondary users 90, sending an email directly to the secondary users 90, or calling the secondary users 90 and dictating the link URL, or the like. In yet another embodiment, the service server 112 may provide email initiation functionality that may include a contact list function that allows a primary user 80 to select their personal contacts from a list.

The service server 112 may wait for secondary users 90 to join the session using the provided URL. The service server 112 may authenticate the secondary users 90 if desired. After processing the web contents using a privacy content protection graphical user interface (GUI) and/or a filter, the primary user 80 may send a protected copy of the webpage it received from the original page server 200 to the service server 112. The service server 112 may send a protected copy of the page to the one or more secondary users 90 who have joined the session. It should be noted that most content in a given webpage is dynamic. The data may be stored in a database and a query may be evaluated to load the data into the webpage at run time. The content of the database used to populate the webpage may change during the time that the page was sent to the primary user 80 and the time that the secondary users 90 join the session. It should also be noted that the privacy protection GUI and filter may be implemented as OS applications or add-ons (or plug-ins) to browser.

A connection between the primary user 80 and the service server 112, and another connection between a secondary user 90 and the service server 112, may now be established. A direct peer-to-peer connection using Interactivity Connectivity Establishment (ICE) may be established. In an embodiment, the direct peer-to-peer connection may be established using Traversal Using Relays around Network Address Translator (NAT) (TURN). In another embodiment, the direct peer-to-peer connection may be establishing using Session Traversal Utilities for NAT (STUN), which because of its scalability, may relieve the server from utilizing computational and network resources. Also, it may help keep the latency of the screen sharing application at a minimum. After the connection has been established, any real time transport protocol may be used (e.g., Web Sockets, WebRTC, and the like).

After a logical connection has been established between the primary user 80 and one or more secondary users 90, control information may flow through that logical connection. This information may include access control tokens for page elements; window or browsing control events, which may include browser tab drag and drop, sizing and scrolling, mouse curser movement, and key strokes executed by the primary user 80, and the like.

To support better synchronization and access control, the privacy protected web content sharing mechanism may benefit from an additional control information connection, such that it may be possible to exchange browser settings and access control information between the primary user 80 and one or more secondary users 90. With the control connection, the primary user 80 and secondary users 90 may synchronize on a compatible screen format (e.g., aspect ratio, screen size, relative frame and font size) during connection establishment. In addition, the cursor position obtained from the primary user may be refreshed in the one or more secondary users' HTML pages dynamically. This may make displaying the webpage at the one or more secondary users' screens from the cursor locations sent by the primary user much easier.

If the screen sizes are not the same, a function may be implemented to adapt the cursor positions transmitted so that they may be displayed correctly at the receiver side. The function may be implemented in an OS application, mobile application or browser add-on (or plug-in). This function may require screen sizes at the receiver and sender and any additional information that may be relevant for display (e.g., renderer version and browser type and other parameters that may differ from user to user). If it proves too difficult to share accurate cursor positions between screens, the primary user 80 may send an indication of what component the cursor is currently hovering over or clicking on. This may enable the remote curser at the secondary user 90 to locate the corresponding URL. In other words, this process may provide for an accurate URL of the webpage at both sides, even with the possibility of a slight mismatch in cursor positions.

It should be noted that the system, as shown in FIG. 2, is a general illustration of an embodiment. The primary user 80 may be loading multiple webpages and may be connected to multiple webpage servers and possibly multiple secondary users 90. In an embodiment, the service server 112 may physically reside at the primary user 80. In this case, the primary user 80 may have web hosting functionalities so that the spectators are able to access the shared page URL.

In another embodiment, the service server 112 may reside at the original webpage server 200. This may be the case if the web server 200 of the page itself wants to offer the service of private screen sharing. One possible use case may be an online shopping webpage that wants a user to share his/her browser screen and will tag the private data and promise the user that no embarrassing targeted advertisements will be displayed. For example, the shopping cart, user name, items recently bought, or other sensitive preference information may be tagged as private data by the web server page designer so that it may be excluded from sharing. The service server 112 may also block the entire advertising or loading reference link from third parties. For the case in which the original webpage page server 200 offers the function of private screen sharing and also functions as the service server 112, the webpage server 200 may have sufficient information and knowledge to determine which parts of the webpage are private and may tag such parts of the page as private statically.

In another embodiment, the privacy protection methods and apparatuses may be used to track and analyze dynamic content elements, as well as privacy tags inserted in a webpage to identify a webpage or parts of the webpage (e.g., elements) as private information, and may generate privacy protection metadata for the protected webpage for sharing. The metadata may be used by a web content sharing application to block private information from being sent to the service server 112 and protecting the private page elements from being downloaded to secondary users' 90 browsers.

Embodiments for manual privacy setting and verification will now be described. When a primary user 80 browses multiple server sites with webpages that do not provide or guarantee privacy protection, the primary user 80 may need to use additional privacy control methods for sharing the webpage information. The private or personal information may be entered and enclosed in various HTML elements (e.g., <div>, <form>, <image>, <video>and <script>) dynamically.

Since privacy may be dependent upon the specific content, privacy may be decided by the primary user 80. For example, an advertising frame may show a product based on a user's personal preferences. The user may want to share the advertising frame with the secondary users 90. The primary user 80 may choose which users receive the privilege of observing the revealed private elements of the webpage. For example, a primary user 80 may assign a privacy level for each of the private areas (e.g., sensitive, very sensitive, personal, and the like) and may create groups of users with certain privacy settings such that the user may share different levels of the privacy content to different groups of users.

Embodiments for a privacy setting and verification method to identify HTML elements and provide a GUI to set privacy levels and groups for each identified element will now be described. Based on the privacy setting, a rule-based filter may be used to modify the privacy tagged HTML elements to generate a version of sharable pages. The primary user 80 may then reload the sharable pages and may verify if it contains private information. Alternatively, the verification may be employed using an embedded HTML5 browser (e.g., Webkit) that is isolated from the original browser containing the user's preference, history, and other personal information. After verification, the primary user 80 may decide if the information may be shared. The identification, tagging and verification steps enable the primary user 80 to confirm that the modified page to be shared with the other users does not contain information that the primary user 80 considers private. Versioning of the web content may provide additional historical information of the web content protected and shared with secondary users 90 at different points in time. This may be useful for supporting long running content sharing applications.

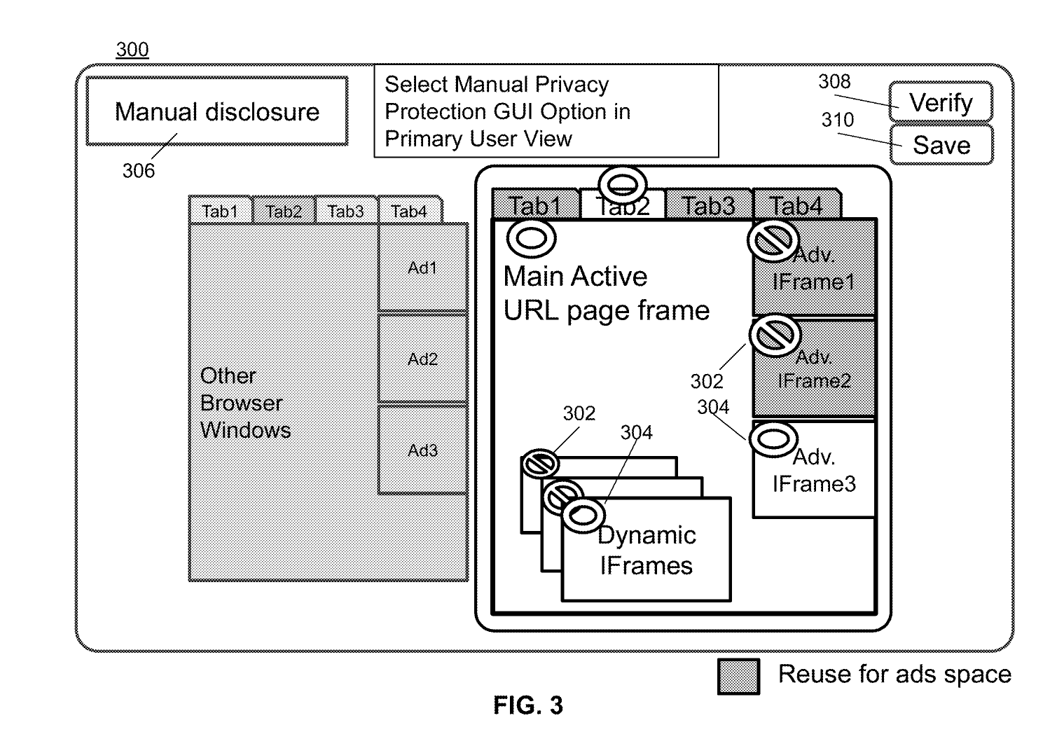

FIG. 3 is a diagram 300 of a graphical user interface (GUI) for manually tagging privacy and public tags to webpage elements. As shown in FIG. 3, the example GUI allows the primary user to determine which parts (i.e., elements) of the page (e.g., HTML5 webpage) are to be tagged as private 302 and which parts are to be tagged as sharable 304 “public” content before sharing the page. A manual disclosure button 306 may be selected to create a pointer icon that may be used to select an HTML page tab and parse contents with different tags. Each tag segment may be highlighted when the user moves the icon, such as a pointer, to the specific segment. A user may click the pointer and select an option to share or protect the tab or HTML element. A user may also set the sensitivity level and private sharing groups as needed.

The user may also click a “verify” button 308 to reload and confirm the dynamic portion of the shared documents containing the sharable 304 or non-private” tagged elements did not change after reloading and that there is no indication of other non-private elements that would reveal user preferences or other undesired content. After the user verifies the sharable content 304 (e.g., HTML elements), the user may click a “submit” button for sharing or click a “save” button 310 to save the sharable page for future use. The privacy tagged areas 302 may be reused for advertisement display areas when loaded by the secondary users' 90 browsers. The reusable areas may be replaced with advertising links (e.g., href or src) that may provide access to advertisement networks that may load new advertisements in the browser of the secondary user 90. Loading of these advertising links may be performed directly in the secondary user's 90 browser or mobile application.

Alternatively, the service server 112 may provide advertising services for the advertising regions in the shared Webpage. In this case, the service server 112 may check the metadata to identify available advertising regions and insert advertising network links from advertisers that may use the service server 112.

Embodiments for automated web element tracking and privacy filtering will now be described. An automated privacy filter may detect HTML elements in the dynamic webpages that may reveal personal preferences. The privacy filter may be implemented as an SDK that may be called upon by applications, browsers, or service servers. The privacy filter may delete personal activities or generate random or designed web traffic to increase the anonymity of user activities.

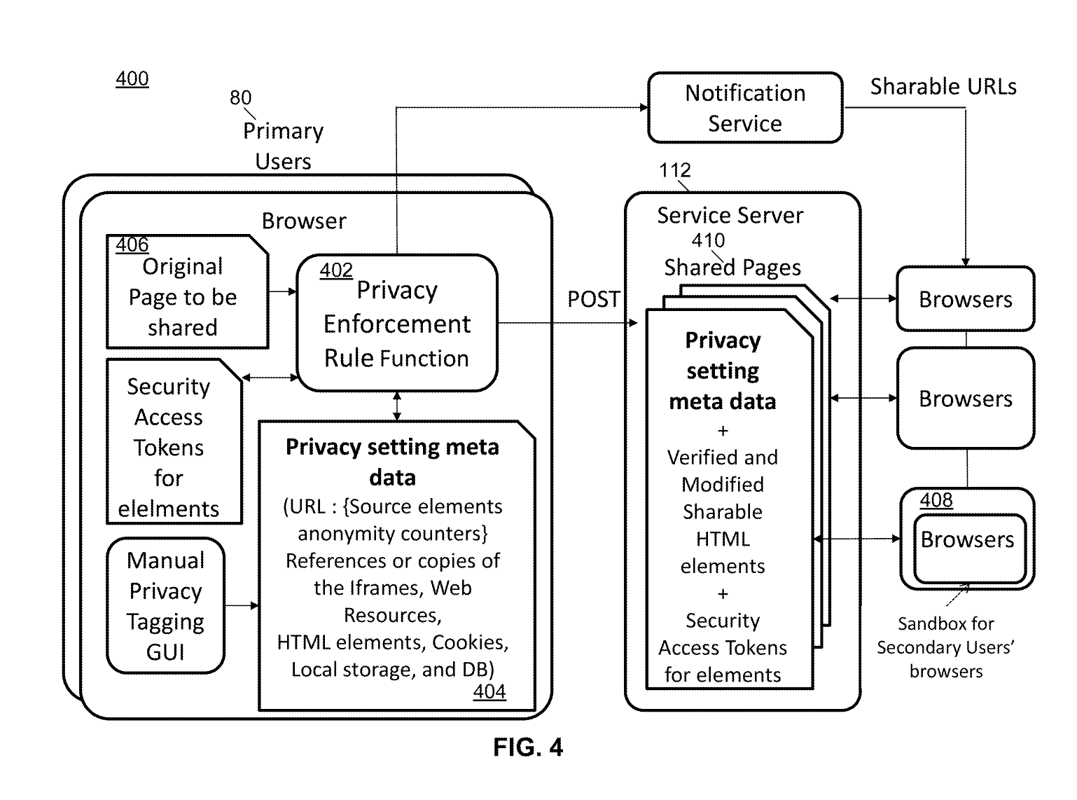

FIG. 4 shows a diagram 400 illustrating how a privacy enforcement rule function 402 may extract a set of privacy control metadata 404 from a privacy tagged webpage 406 in a primary user's 80 browser. The privacy enforcement function 402 may be implemented via a processor implementing client side scripts, such as JavaScript and the like. These functions may also be implemented via special plug-ins in the primary user's 80 browser, or a combination of both.

The metadata 404 may consist of URIs, diversity counts of each URI, privacy settings, security tokens for the URI and references to Iframes, web resources, cookies, HTML elements, and other information stored in local storage and the local database of the HTML5 browser. Multiple versions of privacy protected web content may be kept to support analysis and long running web content sharing applications. The diversity counts may be the number of different types of resources that are loaded dynamically into each HTML element in different versions of each URI webpage.

The privacy filter SDK may have access to the browser event and control application programming interface (API). If both primary users 80 and secondary users 90 have registered to the shared page/screen service and have enabled notification services, the privacy enforcement rule function 402 may perform the following filtering operation method to protect the privacy of a primary user 80 when sharing the Webpage URL. The privacy enforcement rule function 402 may save the URL and elements of the original page. It may then perform privacy enforcement filtering.

Privacy enforcement filtering may include the following steps. The privacy enforcement rule function 402 may turn off a browser setting for “auto word completion”. It may delete queries or cookies that may be attached to the URL of the page to be displayed or shared. It may delete information that may be marked confidential. It may inspect “form data” and encrypt or remove user inputs. If user preference data from a search engine is accessible, the privacy enforcement rule function 402 may delete or modify the user preference data. If history tracking is enabled, the privacy enforcement rule function 402 may export the history data and delete the current history data. The privacy enforcement rule function 402 may execute a script that contains a set of predefined URLs to emulate a set of webpage access events and/or search engine queries to create a new set of anonymous user behavior. This may create more diversity in the categories of user preferences considered by a learning mechanism used by search engines to track personal preferences. Additionally, if location services are enabled, the privacy enforcement rule function 402 may generate random locations that are different from real location data so that the user location that may be recorded at the server side may not be used directly and with a high probability.

The privacy enforcement rule function 402 may perform HTML source element diversity counts. This may include reloading the original dynamic webpage URL and comparing the reloaded version's HTML elements with the HTML elements from the saved previous version. The HTML elements may include URIs and metadata of content inside URIs. The privacy enforcement rule function 402 may also generate version numbers and store the page under the URI.

When dynamic content is created using a web service call, the return values displayed in page elements may be analyzed by the privacy enforcement rule function 402. The analysis may generate a unique signature of elements to support a fast comparison. The elements may be a URI, an image, metadata of a video, or web service return values. The privacy enforcement rule function 402 may keep the signature with the corresponding version of a URI. If the elements between versions are different, the privacy enforcement rule function 402 may save, assign and/or increment the diversity counter to the HTML elements.

The privacy enforcement rule function 402 may repeat the reloading operation for a preselected number of times (e.g., K times). The diversity counter may be used as one indicator for the anonymity of the user preferences to the third parties. When a large numbers of diverse elements are loaded, it is less likely to infer a specific user preference. The privacy enforcement rule function 402 may keep a history of the source diversity counter and signatures for a long period of time, crossing multiple browser sessions, to gain more detailed information of how the web site generates dynamic HTML elements in the dynamic page. For example, a list of recommendations may be used to infer how much the website has accumulated user preference. The URL and associated diversity counts and signatures may be linked with the user's manually selected privacy markings to prevent private content from being shared. If a webpage already has a built-in privacy tag, the built-in privacy tag format may be parsed and linked to a primary user's 80 privacy level, as described above.

The privacy enforcement rule function 402 may also perform privacy tagging and masking. A privacy enforcement filtering rule may be used to generate masks with different transparency levels for elements with low diversity counts such that unpredictable dynamic HTML elements from the same page URL may be masked and tagged with privacy tags by default. The HTML elements that do not change between versions or have large diversity numbers may be displayed with minimal masks to the primary user 80.

The main page to be shared may have a diversity count of 1 for a certain time (e.g., default N time) to make sure that the URL of the page loaded by secondary users 90 will stay the same. The masked page may be used as an indicator to prevent sharing of private information in a public setting or in a meeting presentation. Primary users 80 may override the masked elements or mask the main page manually. The privacy protection rule filter may generate a new set of HTML elements based on the source diversity counter and a user's manual settings. When a webpage contains privacy tag, elements with the privacy tag may be saved and linked with the metadata created by the filter.

The privacy enforcement function 402 may also perform privacy protected page URL sharing. The generated HTML elements may be packed as sharable pages with a generated sharable URL. The URL may be sent to the service server 112. A detailed operation of the service server will be described below. A notification with the generated sharable URL may be sent to one or more secondary users 90 using notification services. Secondary users 90 may receive the shared page 410 using the sharable URL from the service server 112. Alternatively, the browser may be implemented using an embedded HTML5 browser running in a separate sandbox 408 to provide additional privacy control and protection for the secondary user 90. The sharable pages may be encrypted and stored in a server such that it can be described only by a selected group of users to support multiple “private rooms”. The service server 112 may keep multiple versions of the shared page and associated metadata to support long running web content sharing.

The service server 112 may contain shared pages 410 posted by primary users 80. This may provide a level of protection from the posted shared pages 410 because the information may not be accessed directly from the original server 200 that may contain links to advertising servers with user preference and history data. For dynamic links in a shared page 410 that may be rendered directly from cloud servers, the privacy protection filtering steps may provide a first level of detection and protection. The privacy sharing GUI may provide a stage of protection to mask the dynamic pages that may be generated using user history or preference information. The privacy protection GUI may be used for cases that may involve confidential information. A confidential data filtering method may also be added to the automated content filters to parse the web content for copyright or confidential statements.

Privacy protected content sharing service use case scenarios will now be described. In a first scenario, Type A webpages may have privacy tags with embedded scripts to support sharing and/or co-browsing. In a second scenario, Type B webpages, which may be from multiple websites, are without privacy tags and embedded scripts.

When the webpage is designed to include privacy tags and scripts to allow developers to control whether the elements shall be private, these privacy tags may be preserved when executing the URL privacy analysis filter, as described herein. The privacy tag may be considered as a part of the metadata stored with the corresponding page element. After the execution of the privacy filtering rules, the metadata of each element may be updated and sent to the service server.

The primary user 80 may access the webpages from the original web content server 200 using general web browser protocols. After the main URL page is loaded, java scripts and other resources embedded in the HTML pages may be loaded dynamically from multiple websites and advertising servers. Java scripts in the webpage may also be executed to load additional content from web services or resources from other websites. It should be noted that the privacy protection methods and when content sharing methods may be provided without modifying the HTML protocols.

An embodiment providing privacy protection will now be described. An on-window screen sharing event may include copying the webpage to a new tab or an Iframe emulating the top level browser with the previously loaded content. These steps may be implemented with a GUI application, mobile application, browser add-on, or other programming methods that may access the HTML page loaded in the browser tab. A privacy analysis filter API with the URL may be executed for both Type A and Type B webpages. For Type A webpages, the privacy tag may be detected. For both Type A and B webpages, the privacy metadata for the URL page including the privacy tags may be updated. The data may also be encrypted and kept in the browser's local storage, in a primary user's 80 cloud storage, or in a designated storage area in the service server 112. For example, for a shopping site with credit card information defined in private tagged elements, the credit card information may be encrypted or deleted and will not be sent to the secondary user 90. However, the credit card information and personal authentication information may still be sent to technical support staff of the shopping site in order to facilitate the primary user's 80 shopping experience.

A secondary user list may then be entered or selected. Based on privacy metadata, all the private elements (e.g., Iframe, Image, video, href, and the like) may be encrypted. An access right and version of the elements may then be created. For example, the tech support staff may have access to the credit card information but the secondary user 90 may not. For each element, it may be determined if the element is to be instantiated by making it a static element or is to be kept dynamic for the secondary user 90. Alternatively, the original URL may also be replaced with anonymous URLs.

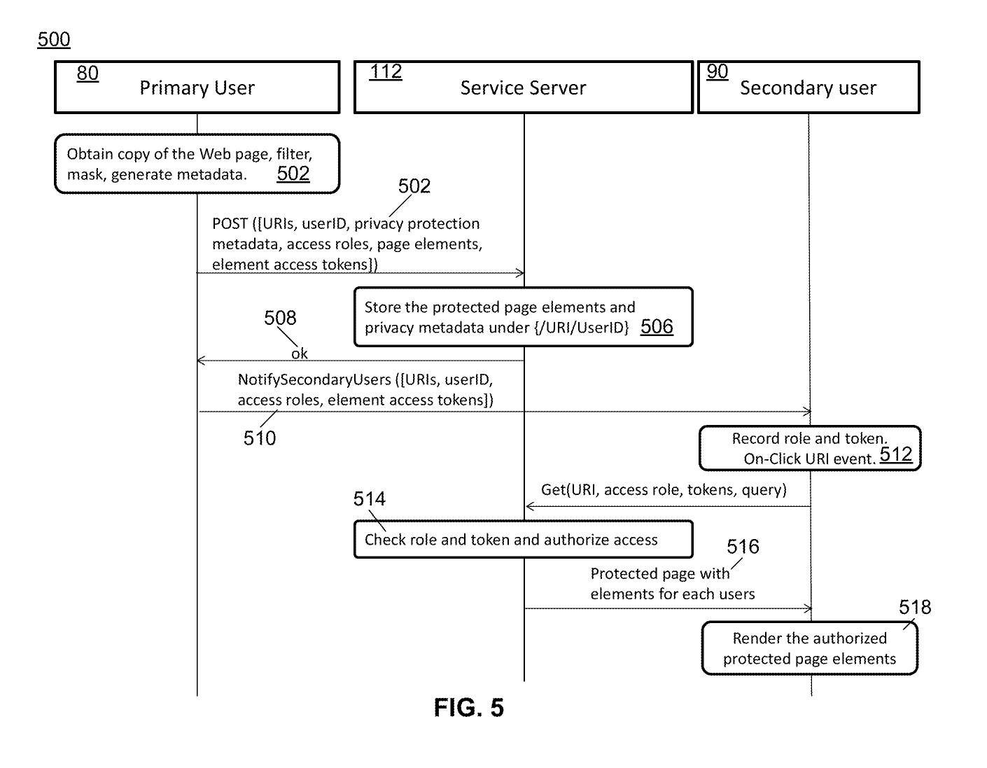

FIG. 5 is a flow diagram 500 of an example privacy protected web content sharing message call flow. FIG. 5 illustrates one possible embodiment of the web content sharing method between a primary user 80, a service server 112, and secondary users 90 with or without the presence of content sharing scripts in the webpage and privacy tags on the designated privacy elements.

The primary user 80 may obtain a copy of the webpage, may employ filtering, masking, and may generate metadata in step 502. The primary user 80 may post URIs, userIDs, privacy protection metadata, access roles, page elements, element access tokens, and the like to the service server 112 in step 504. The service server 112 may store the protected page elements and privacy metadata under {/URI/UserID/} in step 506. The service server 112 may send an indication confirming back to the primary user 80 in step 508. The primary user 80 may send a notification to one or more secondary users 90 including a URI, userID, access roles, page elements, access tokens, or the like in step 510.

The one or more secondary users 90 may record the access roles and access tokens and may access the URI in step 512. Alternatively, the secondary user 90 may retrieve the URI, access role, tokens and query form the service server 112. The service server 112 may then check the access roles and access tokens and authorize or deny access is step 514. If access is authorized, the service server 112 may provide the protected page with elements specific to the secondary user 90 to the one or more secondary users 90 in step 516. The one or more secondary users 90 may view the authorized protected page elements alongside the specific elements added for them in step 518.

It should be noted that the same URI may be supported for both subscribed primary users 80 and any secondary users 90 using URI notification. The secondary users 90 need not subscribe to the service.

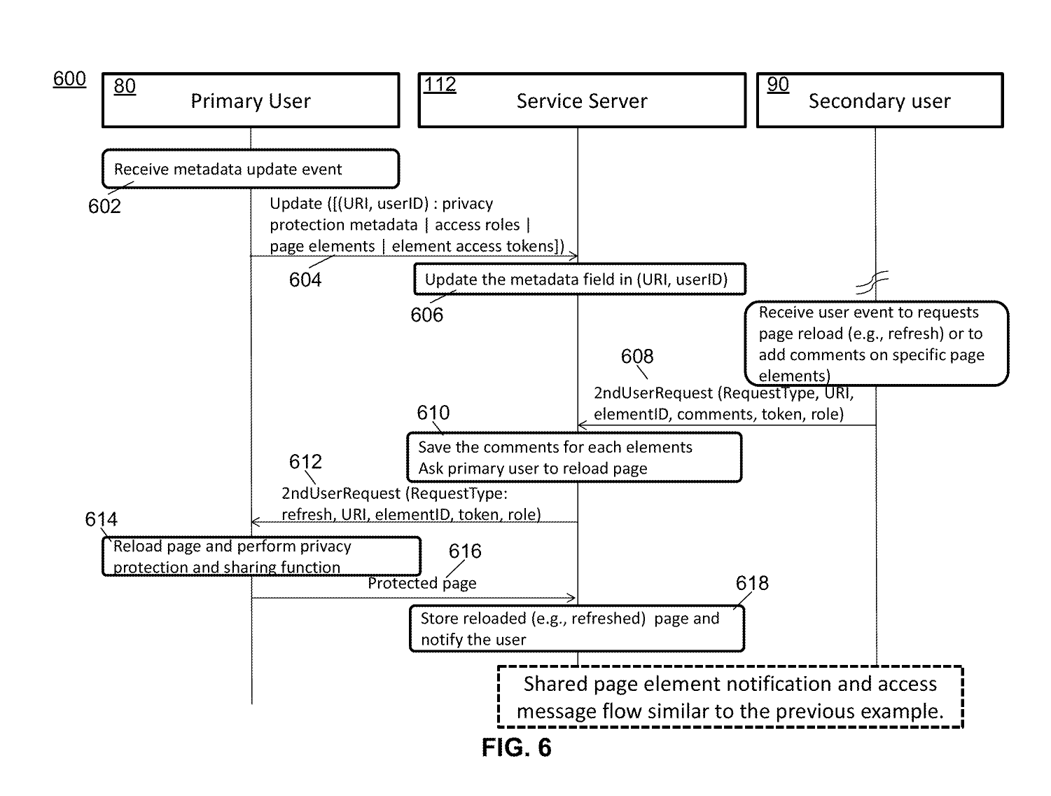

FIG. 6 is a flow diagram 600 of a dynamic update and reload call flow. In an embodiment, a primary user 80 may update the metadata to change access control roles on each page element for each secondary user 90. The secondary user 90 may initiate a request to primary user 80 to reload/refresh the webpage or add a comment to an element (e.g., annotation on the shared element).

The primary user 80 may receive a metadata update in step 602. The primary user 80 may forward the update (e.g., URI, user/ID, privacy protection metadata, access roles, page elements, element access tokens, and the like) to the service server 112 in step 604. The service server 112 may update the metadata field in the URI, userID, or the like in step 606. The secondary user 90 may request a page reload/refresh or may choose to add a comment on a specific page element. The secondary user 90 may send a user request to the service server (e.g., request type, URI, element ID, comments, token, role, and the like) in step 608. The service server 112 may save the comments for each element, if provided, and may also ask the primary user 80 to reload the page in step 610. The service server 112 may forward the user request to the primary user 80 in step 612. The primary user 80 may reload the page and may perform privacy protection and sharing functions in step 614. The primary user 80 may send the protected page to the service server 112 in step 616. The service server 112 may store the reloaded/refreshed page and notify the secondary user 90 in step 618. The shared page element notification and access message flow may use the same flow as described heretofore.

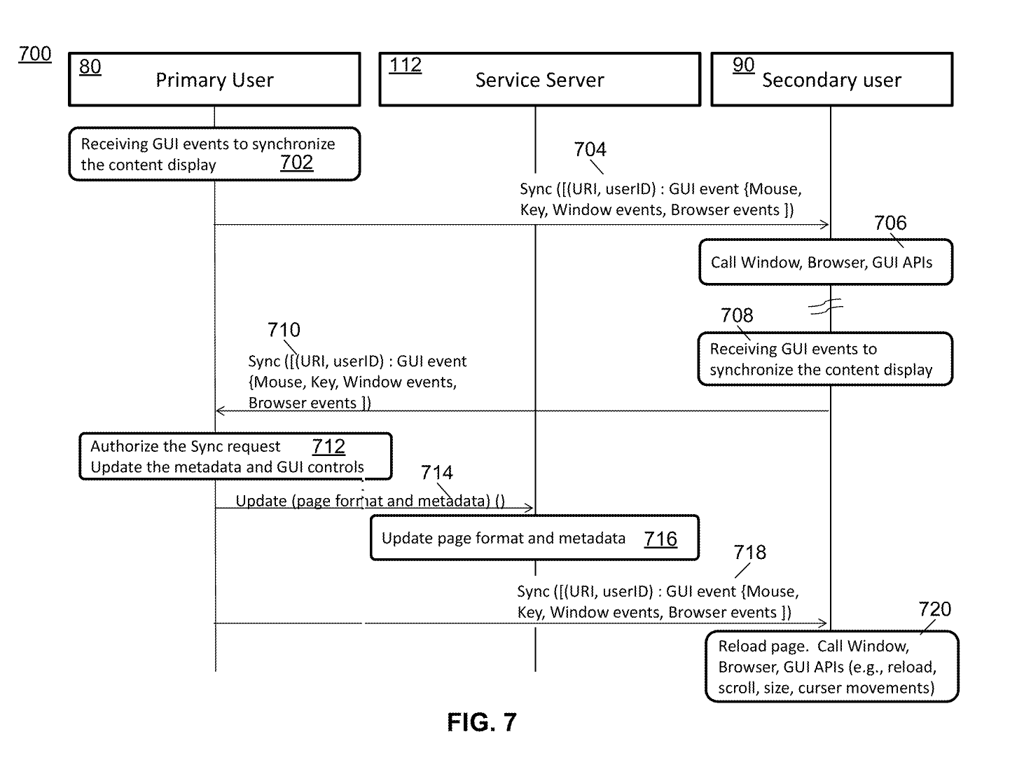

FIG. 7 is a flow diagram 700 of a synchronization call flow between the primary user 80 and a secondary user 90. This message flow provides an example of the synchronization of GUI component control events between the primary user 80 and the secondary user 90. The primary user 80 may send the GUI event to secondary user 90 directly to synchronize the mouse, key and browser display. However, when a secondary user 90 wants to control the display of the shared page elements, a sync message may be sent to the primary user 80 to obtain access permission. Then, the primary user 80 may grant access to the secondary user 90, update the shared elements, and send synchronization messages to the secondary user 90.

The flow diagram 700 may contain personalized shared webpage elements for each secondary user 90. The shared webpage elements may be personalized using encryption, privacy tag extraction, access control, element access tokens, anonymous URL IDs, and the like.

In an embodiment, the primary user 80 may receive a GUI event to synchronize the content display in step 702. The primary user 80 may send a sync signal (e.g., URI, user ID, and GUI event, such as mouse, key, window events, browser events) directly to the secondary user 90 or through the service server 112 in step 704. The secondary user 90 may use the received sync signal to synchronize the call window, browser, or GUI APIs in step 706.

A GUI event to synchronize the content display may also be received at the secondary user 90 in step 708. The secondary user 90 may send a sync signal (e.g., URI, user ID, and GUI events such as mouse, key, window events, browser events) directly to the primary user 80 or through the service server 112 in step 710. The primary user 80 may authorize the sync request received by the secondary user 90 and may update the metadata and GUI controls in step 712. The primary user 80 may send an update to the service sever 112 (e.g., page format, metadata) in step 714. The service server 112 may update the page format and the metadata in step 716. The primary user 80 may then send a sync signal (e.g., URI, user ID, and GUI events such as mouse, key, window events, browser events) directly to the secondary user 90 or through the service server 112 in step 718. The secondary user 90 may then reload the page, call window, browser, or GUI APIs (e.g., reload, scroll, size, and cursor movements) in step 720.

To support multiple types of browsers, privacy tracking and element level content sharing with personalized viewing function APIs may be packaged as a SDK. The API input may be the metadata privacy level (e.g., a level defined by privacy tag, custom privacy rules, or diversity counts obtained from an analysis filter). The SDK may provide secure open interfaces to listen to operating system (OS) level GUI events and control APIs. The SDK may also provide interfaces to listen to top level browser events and browser tab control APIs.

The detailed integration of the SDK to different browsers and OSs is the same as window applications, a browser extension, or a mobile application. It may not require modification of a browser to control multiple browsers. In addition, it may listen to the top level window event and browser control events and may call the top level window API and browser API (including tab control API). This may enable the total control of the browser once it obtains security and access rights to the browser's look and feel, as well as the content in each tab. As a result, it may be possible to zone, scroll and resize the elements of the page.

With the control of browser events and access rights, the content sharing SDK may either be packaged as a mobile application or as a browser extension. It may also be embedded in a special page that may control other tabs in the browser during run time. Once a new tab is dragged and dropped into the browser with the top level tab controlled by the SDK, the privacy content sharing SDK may be dynamically loaded from service server to primary user.

The SDK may also be used in a window script with access rights to window applications, including the browsers and other window applications. This may allow it to hover and select browser tabs, and also click and enable Web content sharing and privacy protection features. This may support context aware screen masking. For example, if a laptop is placed in a public area, all of the screen may be masked until the primary 80 user unmasks the application and shares it. It may be possible to detect if the laptop is in a public area by checking the location service, network service, or connectivity to docking station.

The SDK may also be packaged in the service server 112. In this case, the service server 112 may need to have a proxy server function, such that the dynamic web content associated with the primary user 80 is intercepted by the proxy server and stored in the proxy server. The server script or application may then access the web content in the log and perform privacy filtering and masking functions.

It may be beneficial to have controlled personalized views for sharing different page elements to different users with different relationships to the primary user 80. The personalized views may last over multiple sessions and may support updates on the privacy metadata. The updates may include privacy protection metadata, or possibly content masks, and the like. Embodiments including these new features will now be described.

Embodiments described herein focus on supporting the primary user 80 to only share privacy protected web content using a service server 112, as opposed to typical co-browsing services. The privacy detection described herein tracks and analyzes content that may potentially infer or reveal personal preferences or browsing history. After web elements in a page are identified and verified, the privacy protected elements may be encrypted and protected by the primary user 80 (e.g., by the SDK, the primary user's 80 browser or by scripts running in the primary user's 80 browser). In this way, secondary users 90 may not access the protected elements.

Creating a protected version of the web content for sharing has the advantage of tracking the shared contents for long running sessions. It also has the advantage of supporting primary users 80 and secondary users 90 to update or comment on the shared version of the protected page using existing web collaboration tools. To support the sharing of the privacy protected content, another layer of access control and privacy protection, namely, URL privacy protection, may be added.

With the protected web content stored in the service server 112, an additional level of privacy may be achieved by hiding the URLs from the original webpage. The URI of the main page and the source of dynamic content may be hidden by instantiating the contents for the element in the service server 112. The shared content may not change between the time it is shared and the time that the secondary user 90 reloads the contents. This may also provide a basis for support of version control of shared information, which may be different than that of typical co-browsing.

For example, if an original page is http://www.example.com/OriginSRC, it may be changed to http://www.mySharingServiceServer.com/time-stamp-anonymousSRC. In this way, secondary users 90 may not infer any private information about the primary user 80 by inspecting the true URL of the page. This functionality may be implemented by storing a simple lookup table that maps the original URI/SRC to the Anonymous URI/SRC with timestamps.

In addition to basic page/screen sharing, the service server 112 may support different “shared” views to different secondary users 90 using a dictionary of private snippets of a webpage. The users associated with such a snippet may have access to that particular snippet. The snippet may contain access control methods to decide what portion of the web elements may be viewed or updated by each of the users. When a shared content notification is sent to one or more secondary users 90, the server may check the dictionary to grant access.

Alternatively, the customized page for each of the secondary users 90, according to his/her privacy settings, may be set by the primary user 80. The primary users 80 may have the option to set the privacy settings of the dictionary. The metadata used to describe the shared web content elements may be stored in the dictionary with security protection. In this case, the shared content privacy protection may be updated by the primary user 80. When the primary user 80 changes the privacy settings of any of the elements on the webpage, the dictionary may be updated accordingly. The primary user 80 may send a notification to one or more secondary users 90 when the primary user 80 has verified the content. The secondary user 90 may then access the updated web content in the service server.

The webpage transmitted from the service server 112 to the secondary user 90 may include special code (e.g., client side JavaScript) that may block the secondary user 90 from requesting any resource on the displayed webpage. For example, the event “LinkClicked( )” may be detected and the system may cancel the navigation, or the like.

By default, the client side Javascript at the secondary user's 90 webpage may cancel any navigation issued by the secondary user 90. This behavior may change if the primary user 80 gives certain privileges or authorities to that particular secondary user 90. For example, the primary user 80 might give the privilege for one of the secondary users 90 to click different items in an inventory and check the details of such items and compare them. But the primary user 80 may not give that secondary user 90 the right to purchase an item. This enhancement may extend the basic webpage sharing with personalized “views” of content with fine granularity access control on shared page elements.

In an embodiment, giving privileges may be the sole right of the primary user 80 and may be given in the form of tokens sent from the primary user 80 to the secondary user 90 directly. The primary user 80 may keep a database of the issued tokens and their expiry time as well as the corresponding secondary user IDs that each token was issued to. The database may also include the kind of requests that this token authorizes the secondary user 90 to issue.

Once a secondary user 90 receives a token, it may disable its client side script that prevents it from submitting requests to the service server 112. For any request that the secondary user 90 submits to the service server 112, it may submit the token issued by the primary user 80 along with the request. This may be in the form of a cookie submitted with the request.

The service server 112 may receive the request and may query the primary user 80 to determine if that particular user has the privilege of issuing that request. The service server 112 may submit both the token submitted by the secondary user 90 and the secondary user ID. The primary user 80 may check its privileges database to determine if the secondary user 90 can issue such a request. It may be the sole responsibility of the primary user 80 to determine if that particular user has the right to initiate such a request. If a primary user 80 wishes to revoke a privilege it has issued, it can simply delete the token from its database or may set an expiration date for a token in the past.

If the primary user 80 determines that the secondary user 90 indeed has the correct privileges, then it may issue a command to the service server 112 requesting the new webpage that the secondary user 90 requested. The service server 112 may send the newly requested page to the primary user 80 and all the secondary users 90. In the end, it may be the primary user 80 who issued the command that resulted in fulfilling the request, but this may be transparent to the secondary users 90 who see the new page as if the secondary users 90 were the originator of the request. This example highlights an important factor in the application process, the primary user 80 may have the sole authority to issue commands and the webserver merely proxies such commands from any secondary user 90 to the primary user 80.

The service server 112 may distinguish between the primary user 80 and the secondary user 90. This may be necessary, as different users have different privileges. Only the primary user 80 may issue page requests. It should be noted that the primary user 80 may bear the responsibility of privacy as well as confidentiality of the information. Once the page is shared with secondary users 90, the information may be disclosed.

In an embodiment, there may be a special client side controller code (like JavaScript) that may be part of a webpage transmitted to the secondary user 90. For example, such code may be generated by the service server 112, and inserted into the page content delivered from the service server 112 to secondary users 90. This extra code may be invoked when steering and control messages from the primary user 80 arrive. This extra code may be responsible for moving the primary user's 80 cursor, scrolling the page, highlighting elements, clicking on links, typing, and the like.

The primary user 80 may give a secondary user 90 the right to take control of the page-viewing. Stated differently, the secondary user 90 may scroll down on the page, enter text at the webpage, fill out forms, and the like. This privilege may be in the form of a token. In this case, there may not be a request issued to the service server 112 and all these actions (typing text, scrolling down the page) may be done at the secondary user 90 site.

The page-viewing feature may be implemented by capturing the commands from the secondary user 90 and executing them at the primary user's 80 site. The secondary user 90 may be equipped with a processor configured to perform a steering function. The steering function may be responsible for capturing the actions (e.g., mouse clicks and scrolls) performed by the secondary user 90 and sending them to the primary user 80 along with the token. The primary user 80 may check to see if that particular secondary user 90 has the page-viewing feature privilege, and if so, it may execute the commands. Once the commands are executed, they may be captured again by a corresponding steering function executed by a processor at the primary user's 80 site. The commands may be sent to all the secondary users 90 as if these commands were issued by the primary user 80. In this way, the need to establish a direct connection between the secondary user 90 who has the page-viewing privilege and all the remaining secondary users 90 is avoided. Also, it may keep the procedure centralized and in the control of the primary user 80.

The service server 112 may set cookies at both the primary user's 80 site and the secondary user's 90 site. The cookies may be related to the screen sharing application. These might include viewing size preferences, font sizes, enabling sound, and other options.

At different sessions, a user may be a secondary user 90 or a primary user 80. The server can use both normal webpage cookies and screen sharing application-specific cookies for the primary user 80 and only use screen sharing application-specific cookies for the secondary user 90. For example in an online shopping application where the user shares their screen, the webserver may use normal cookies for the primary user 80 (e.g., the user's shopping cart, credit card number, preferences and so on) as well as cookies for the screen sharing application. But, for the secondary users 90, only the screen sharing application related cookies may be used.

It may be assumed that the created website sent to the secondary user 90 may contain client side scripts, such as JavaScript. Client side JavaScript has become an integral part of modern web applications. The secondary user 90 may not be able to control the webpage, since special code in the webpage may be inserted to block such control. Any changes in the state of the webpage may have to emanate from the primary user 80. Any client side scripts that are used to display public content of the webpage may not depend on cookies. This is important because the secondary user 90 may not have the necessary cookies associated with the primary user 80. It should be noted that this restriction may only be on client side code. For server side code, it may be permissible for the content to depend on cookies. If accessing cookies from the client side scripts is required, then the secondary user 90 may be provided with the cookie without compromising the privacy of the primary user 80.

When the session is established between a primary user 80 and a secondary user 90, the primary user 80 may supply an encrypted version of the necessary cookies to the secondary user 90. Since cookies are a {name, value} pair the “name” may be without encryption and the “value” field may be encrypted. A key for encryption having a specific expiration time may be used. The primary user 80 may set the expiration time of that key. A client-side script residing at the secondary user 90 site may be responsible for getting and setting the necessary cookies.

The encrypted “value” of the cookies may be prefixed by a known sequence to all parties (e.g., primary users 80, secondary users 90, and the service server 112). The secondary user 90 may have client side scripts that are able to intercept any access to the cookies. An interceptor may check if the “value” field of the requested cookie has an agreed upon sequence, and if so, it may send a request to the primary user 80. The request may include receiving the true decrypted value of the cookie. The primary user 80 may check the encrypted “value” and check what key was used to encrypt that field. The primary user 80 may decide based on the expiration time of that key, among other factors, whether to provide the actual cookie value to the secondary user 90. The actual cookie may then be sent to the secondary user interceptor and the interceptor may provide the actual decrypted cookie to the calling script. In this way, the actual cookie value may never be stored at the secondary user's 90 site and the primary user 80 may revoke the privileges of any of the secondary users 90 at any time.

In addition to the privacy protection filtering and verification GUI functions described above, additional functions may be used to support enhanced sharing features that may be applied to the security and synchronization aspects of the web content sharing sessions.

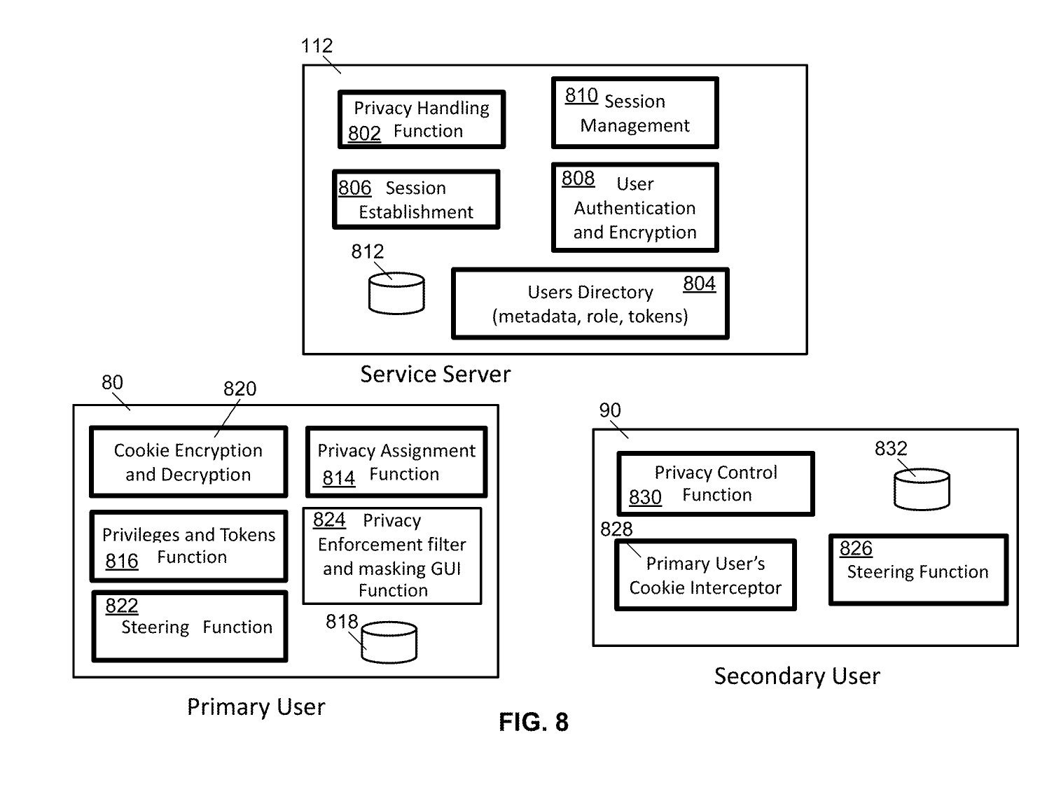

FIG. 8 shows these enhancement functions, which may be located at the service server 112, the primary user 80, and the one or more secondary users 90.

The service server 112 may include at least one processor configured to perform one or more functions related to the co-browsing session. The service server 112 may include a processor configured to perform a privacy handling function 802 that may be responsible for formatting the page, removing private parts of a page, and inserting new content to polish the new page. The service server 112 may also include a user directory 804 that may contain contact information for each user (e.g., a set of contacts for each primary user 80) as well as privacy settings for each user. This information may be stored at both the service server 112 and the primary user 80 site.

The service server 112 may also include a processor configured to perform a session establishment function 806 that may be responsible for initiating the session. This may be done using SIP, Jingle, XMPP, or a similar session establishment protocol. The session establishment function 806 may initiate the session with the secondary user 90 when the secondary user 90 joins the session. In addition, it may help with session establishment between the primary user 80 and the secondary users 90. The service server may also include a processor configured to perform an authentication and encryption function 808. The authentication and encryption function 808 may perform encryption for transmitted pages as well as validation to verify which users may have the authority to view items. In addition, the service server 112 may also include a processor configured to perform a session management function 810. The session management function 810 may be responsible for revealing parts of the webpage that the primary user 80 has specified for certain allowed users. The service server 112 may also contain one or more databases 812. The one or more databases 812 may store, for example, privacy protection metadata, contents of dynamic web pages and session information.

The primary user 80 site may include at least one processor configured to perform one or more functions related to the co-browsing session. The primary user 80 may include a processor configured to perform a privacy assignment function 814, which may be responsible for giving and revoking permissions for parts of the website that are determined to be private. The privacy filtering riles may be employed in this function. The primary user 80 site may also include a processor configured to perform a privileges and tokens function 816. The privileges and tokens function 816 may be involved in the case where secondary users 90 are given permission to navigate and control shared webpages of the primary user 80.

Requests may be proxies to the primary user 80 and may be checked against a database 818 to verify if a particular secondary user 90 is allowed to perform such an action. The primary user 80 site may also include a processor configured to perform a cookie encryption and decryption function 820 that may be responsible for providing secondary users 90 with cookie, other metadata such as LocalSessionStorage, and local content that may normally reside at the primary user 80 site. This function may also choose not to provide requested cookies to the secondary user 90 if the function determines that the session is compromised, or for any other particular reason.

The primary user 80 site may also include a process configured to perform a steering function 822. The steering function 822 may capture commands from the primary user 80 and may transmit the commands to the secondary user 90 sites. It may also be responsible for receiving commands from authorized secondary users 90 and may validate these commands with the privileges and tokens function 816. If the command is valid, it may execute the command (e.g., key strokes, mouse clicks, and the like) at the primary user 80 site.

The primary user 80 site may also include a processor configured to perform a privacy enforcement filter and masking GUI function 824. The privacy enforcement filter and masking GUI function 824 may implement the privacy protection function described above with reference to FIG. 4 as well as functions required to support the GUI operation described above with reference FIG. 3.

The secondary user 90 site may include at least one processor configured to perform one or more functions related to the co-browsing session. The secondary user site may include a processor configured to perform a steering function 826 that is responsible for receiving commands from the primary user 80 site. It may also be responsible for executing these commands locally. If a particular secondary user 90 is given the privilege of navigating the webpage, this function may be responsible for capturing the navigation commands and transmitting them to the primary user 80, who may then determine if the commands are to be executed or not. The secondary user 90 site may also include a processor configured to perform a primary user cookie interceptor function 828. This function may be responsible for intercepting private cookies of a webpage. These cookies may be prefixed by a sequence known to all parties. This function may then query the primary user 80 for the actual value of the cookie.

The secondary user 90 site may also include a processor configured to perform a privacy control function 830. The privacy control function 830 may provide similar a privacy protection function as described above with reference to FIG. 4. The privacy control function 830 may protect the webpages of the secondary user 90 when the secondary user 90 shares web pages to the primary user 80 and other secondary users 90. The secondary user 90 site may also include one or more databases 832. The one or more databases 832 may store privacy protection metadata and dynamic web pages for the secondary user 90.

The functions described above may be implemented via a processor implementing client side scripts, such as JavaScript and the like. These functions may also be implemented via special plug-ins in the browsers or a combination of both.

An example of an embodiment involving an HTML based mobile application and game will now be described. HTML5 based games are gaining popularity, especially for mobile users. It has also become customary for players of games to have spectators. Sometimes, the game players may decide not to show part of the personal information generated in the game. For example, the players may want to hide information about strategy, specific location on a map that may be a secret bonus location, the contents of the player's inventory, the Player's Heads Up Display (HUD), the amount of in-game cash that the player possesses, or the value and properties of a certain rare item that the player possesses. This may be done by specifying (in the HTML) that certain objects in the gameplay such as the map or inventory are private.

With the privacy protection method, the spectators may not view the privacy-protected elements unless the player gives permission. While protecting the user from sharing private information with other players, the user may still share private information with the game server. The game server may relay the portion of shared information to spectators and may display targeted advertisements for the spectators in the screen portion that was allocated for the display of private information for the primary player.

The game server may display advertisements based on a player's actions. For example if the player has slayed 20 monsters in a game and has moved two levels, the spectators may be impressed with the player's performance. The game server may display an advertisement to the spectators of certain items that are being used in the game at the times they are being used. For example, when the player is using his sword, armor, and the like, the game server may display the sword, armor, and the like in an advertisement.

If the spectators are players that play the game, the game server may know the player's profile. The game server may customize the advertisements based on the user's profile. For example, the spectator may watch the player use a repeated skill to slay enemies. The server may know that the spectator tried to learn the skill in the past but failed. The server can then shows an advertisement of a special offer to purchase that skill or a specific tutorial on how to learn that skill.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for protecting a primary user's privacy during a shared web session, the method comprising:
selecting, by a service server, shareable content of the primary user's web browser by comparing elements in versions of a website to determine a difference in web site elements, wherein the shareable content comprises static elements and dynamic elements of the web site unaltered by the user's previous interactions with the web site;
selecting, by the service server, private content of the primary user's web browser by comparing elements in versions of the website to determine a difference in web site elements, wherein the private content comprises dynamic elements of the web site that have been personalized based on the primary user's previous interactions with the web site; and
sending, by the service server, a uniform resource locator (URL) to a secondary user to initiate the shared web session during which only the selected shareable content of the primary user's web browser is available to the secondary user.

2. The method of claim 1, wherein the private content comprises one or more of targeted advertisements personalized to the primary user, reference links from third parties, and personal data.

3. The method of claim 1, wherein the shared session permits the secondary user to interact with the sharable content of the screen.

4. The method of claim 1, further comprising:
replacing at least a portion of the blocked private content with targeted ads personalized to the secondary user.

5. The method of claim 1, further comprising:
establishing a direct connection between the primary user and the secondary user; and
transmitting control information over the direct connection, wherein the control information comprises access control tokens for web page elements and browser control events.

6. The method of claim 1, wherein the URL from the service server comprises a modified version of an original URL accessed by the primary user, such that the secondary user cannot decipher the original URL when accessing the shared URL.

7. The method of claim 1, wherein the selecting shareable content and the selecting private content is performed manually by the primary user.

8. The method of claim 1, wherein the selecting private content comprises using an automated privacy filter to detect dynamic elements that contain personal information or browsing preferences of the primary user.

9. The method of claim 8, wherein the automated privacy filter performs one or more privacy enforcement functions comprising:
turning off automatic word completion in a browser setting;
deleting queries or cookies attached to a URL of the web page;
deleting information that is marked confidential;
inspecting form data and encrypting or removing user inputs;
deleting or modifying primary user preference data from search engines;
exporting history data and deleting current history;
executing a script that contains a set of predefined URLs to emulate a set of web page access and/or search engine queries; and
generating a random location that is not the same as the real location.

10. (canceled)

11. The method of claim 8, wherein the automated privacy filter performs privacy tagging and masking functions comprising:
generating masks with different transparency levels for elements of the web page with low diversity counts, such that unpredictable dynamic elements from the web page may be masked and tagged with privacy tags by default.

12-14. (canceled)

15. A server for protecting a primary user's privacy during a shared web session, the system comprising:
a communications interface;
a memory coupled to the communications interface, wherein the memory stores an electronic request processing application; and
a processor in communication with the memory, wherein the processor executes the electronic request processing application stored in the memory, the electronic request processing application comprising program instructions for:
selecting shareable content of the primary user's web browser by comparing elements in versions of a website to determine a difference in web site elements, wherein the shareable content comprises static elements and dynamic elements of the web site unaltered by the user's previous interactions with the web site;
selecting private content of the primary user's web browser by comparing elements in versions of the website to determine a difference in web site elements, wherein the private content comprises dynamic elements of the web site that have been personalized based on the primary user's previous interactions with the web site; and
sending a uniform resource locator (URL) to a secondary user to initiate the shared web session during which only the selected shareable content of the primary user's web browser is available to the secondary user.

16. The server of claim 15, wherein the private content comprises one or more of targeted advertisements personalized to the primary user, reference links from third parties, and personal data.

17. The server of claim 15, wherein the shared session permits the secondary user to interact with the sharable content of the screen.

18. The server of claim 15, further comprising program instructions for:
replacing at least a portion of the blocked private content with targeted ads personalized to the secondary user.

19. The server of claim 15, further comprising program instructions for:
establishing a direct connection between the primary user and the secondary user; and
transmitting control information over the direct connection, wherein the control information comprises access control tokens for web page elements and browser control events.

20. The server of claim 15, wherein the URL from the service server comprises a modified version of an original URL accessed by the primary user, such that the secondary user cannot decipher the original URL when accessing the shared URL.

21. The server of claim 15, wherein the selecting shareable content and the selecting private content is performed manually by the primary user.

22. The server of claim 15, wherein the selecting private content comprises using an automated privacy filter to detect dynamic elements that contain personal information or browsing preferences of the primary user.

23. The server of claim 22, wherein the automated privacy filter is configured to perform one or more privacy enforcement functions comprising:
turning off automatic word completion in a browser setting;
deleting queries or cookies attached to a URL of the web page;
deleting information that is marked confidential;
inspecting form data and encrypting or removing user inputs;
deleting or modifying primary user preference data from search engines;
exporting history data and deleting current history;
executing a script that contains a set of predefined URLs to emulate a set of web page access and/or search engine queries; and
generating a random location that is not the same as the real location.

24. (canceled)

25. The server of claim 22, wherein the automated privacy filter perform is configured to perform privacy tagging and masking functions comprising:
generating masks with different transparency levels for elements of the web page with low diversity counts, such that unpredictable dynamic HTML elements from the web page may be masked and tagged with privacy tags by default.

26-28. (canceled)
